(19) United States
(12) Patent Application Publication
(10) Pub. No.: US 2011/0119898 A1
(43) Pub. Date: May 26, 2011

(54) METHOD FOR MACHINING A LAMINATE

(75) Inventors: Marcel Blanchet, Niederglatt (CH); Roland Kappaun, Uhldingen-Muhlhofen (DE); Walter Zulauf, Gutenburg (CH); Hans-Ulrich Kurt, Kriegstetten (CH); Rudolf Güdel, Solothurn (CH); Rudolf Heid, Luterbach (CH)

(73) Assignees: GÜDEL GROUP AG, Langenthal (CH); 3S SWISS SOLAR SYSTEMS AG, Lyss (CH)

(21) Appl. No.: 12/992,659

(22) PCT Filed: May 8, 2009
(86) PCT No.: PCT/CH09/00150

§ 371 Date: Jan. 5, 2011

(30) Foreign Application Priority Data
May 16, 2008 (EP) 08 405 137.4

(51) Int. Cl. B23P 17/00; B23P 23/04

(52) U.S. Cl. 29/527.1; 29/33 R

(57) ABSTRACT

In a method for processing a laminate, which comprises at least one solid plate, particularly a glass plate, prior to a lamination step at least one location marking is applied to the solid plate and at least one distance and/or angle value of the solid plate is determined with respect to the location marking. Following the lamination step, the laminate is processed, wherein the laminate and a processing tool are automatically positioned relative to each other as a function of the location marking and the at least one distance and/or angle value. Prior to lamination, the solid plate can be easily measured, the edge thereof can be detected both mechanically (such as by a sensor) and without contact (such as optically, by way of a camera), and common, in particular automated, methods can be used for measuring. Following lamination, which makes a detection of the edges of the solid plate more difficult, processing can be carried out, supported by the applied location markings and the detected distance and/or angle value (or a plurality of such values). It is therefore no longer necessary to still detect the edge of the solid plate after lamination.

### TECHNICAL FIELD

The invention relates to a method for machining a laminate that has at least one solid plate, in particular a glass plate. The invention further relates to a system for machining such a laminate.

### PRIOR ART

Laminates have a wide field of application and can have very different layer systems. One group of laminates has one or more solid plates that lend the laminate shape stability. Glass plates often serve as solid plates, particularly when the laminate is to be completely or partially transparent. Examples of such laminated glasses are composite glasses that are used in glazing automobiles or buildings.

One specific application of such laminates is, moreover, solar panels (also called solar modules). It is known to construct such solar panels by electrically interconnecting a plurality of mechanically sensitive solar cells (photovoltaic cells, for example silicon-based thick film solar cells), and to enclose them in a layer system. The layer system provides mechanical stability and protects the enclosed cells from weathering influences or mechanical impairment. The layer system can, for example, be based on a glass substrate transparent to the relevant components of the insolation, and on a back-side film, between which the solar cells and the electrical connectors connecting them are enclosed. Films made from EVA (ethylene-vinyl acetate) or another suitable material are introduced between said layers such that the layer system can be laminated together under the influence of heat and pressure. The solar cells can be surrounded by a frame.

It is often required when producing such laminates for sections of laminating layers or of the back-side film that project beyond the solid plate to be separated after the lamination. A plurality of measures are known for this purpose:

Thus, U.S. Pat. No. 4,067,764 (J. S. Walker, W. C. Kittler) describes a solar panel comprising a glass plate, two PVB layers, between which solar cells are arranged, and a PET layer that terminates the layer system. The PET layer stands out from the other layers such that it can be fastened on a solid base plate made from metal. After the lamination, the projecting part of the PET layer is cut off. No details concerning the process step of cutting off are disclosed. It is to be assumed that the cutting off is performed manually in a conventional way, for example with the aid of a knife with a sharp blade.

Manually cutting off the edge regions is, however, time-consuming and there is a substantial risk of injury to staff. Attempts are therefore being made to use special tools for cutting off, and also to automate this operation:

EP 0 861 813 B1 (Bottero) relates to a cutting device for cutting off a peripheral section of a flexible layer that projects above a plate that is coated with the layer, for example in order to cut intermediate layers when producing laminated glass. The device comprises a motor-driven rotating cutting disk and also stop means for the peripheral section, said cutting disk and stop means being arranged tangentially at a peripheral surface of the cutting disk and exerting a force counter to the force of the cutting disk at the cutting point. The stop means can comprise a rotatable stop plate whose axis is preferably oriented obliquely to the axis of the cutting disk 34.

DE 34 28 547 C2 (Central Glass/Toray Engineering) relates to a cutting device for cutting off an outer seam, protruding above the two-dimensional area of plate glass layers, of an intermediate layer arranged between the plate glass layers and made from PVB. A band knife unit that can be moved along the periphery of the glass layers is used for this purpose. In order to prevent the cut-off outer seam from becoming entangled in the rotating disks of the band knife unit, the cutting device comprises a sliding piece with a stripper edge, and devices for repairing the cut-off outer seam. The cutting device is guided during the cutting-off operation along the outer edge of the glass plate layers of the laminate.

EP 0 845 440 B1 (Central Glass) relates to a further device for cutting off the edge region of an intermediate layer of a laminated glass plate. The device comprises a robot arm with a robot hand that holds a detachable cutting blade; the cutting blade is moved away from the edge region of the glass plate when a specific resistance force is exceeded.

In the production of solid plates, in particular glass plates, size tolerances in the range of 0.5-2 mm are to be expected. In case the precise separation of the projecting edge regions is required, the cutting off must be aligned with the edge of the respective plate. In the case of all the methods mentioned, however, the problem can arise that the edge of the solid plate can be detected only with difficulty both mechanically and in a contactless fashion because of the laterally oozing laminating layers, the various extents of the layers and/or the back-side film. This renders it difficult to cut off the projecting section uniformly with reference to the solid plate, particularly when the cutting off is to be done in an automated fashion, and can lead to excessive wear or damage to the cutting tool when the latter makes contact with the plate (particularly with hardened glass).

The same problem also arises with other machining operations of the laminated layer system that are to be performed in a geometric reference to the edge of the solid plate, for example when the laminate is to be provided with a frame, or when specific modules are to be fitted or installed at the prescribed intervals.

### SUMMARY OF THE INVENTION

It is an object of the invention to provide a method pertaining to the technical field stated at the beginning, and a corresponding system, which enable precise machining of laminates.

The solution to the object is defined by the features of Claim 1. In accordance with the invention, prior to the lamination step, at least one location marking is applied to the solid plate, and at least one distance and/or angle value of the solid plate is determined with reference to the location marking. Following the lamination step, the laminate is machined, the laminate and a machining tool being automatically positioned relative to one another as a function of the location marking and the at least one distance and/or angle value.

A distance value can, for example, be a distance of an edge or of a corner from the location marking. The values can also be measured in a coordinate system that is defined by the location marking or a plurality of location markings. An angle value is yielded from an angle between two straight lines that are defined by the solid plate and/or the location markings, or are yielded from the coordinate system.

Prior to the lamination, the solid plate can be measured directly, its edge can be detected both mechanically (for example by a feeler) and in a contactless fashion (for example optically, by means of a camera), and it is possible to use conventional, in particular automated, methods of measurement. Following the lamination, the detection of the edges of the solid plate is rendered difficult or virtually impossible. However, it is now possible in the context of the invention to perform the machining with the support of the applied location markings and the detected distance and/or angle value (or a plurality of such values). It is therefore no longer necessary to still detect the edge of the solid plate following the lamination.

An inventive system for machining a laminate that has at least one solid plate, in particular a glass plate, correspondingly comprises

a) a marking station for applying a location marking to the solid plate;

b) a measuring station for determining at least one distance and/or angle value of the solid plate with reference to the location marking;

c) a laminating station for laminating the laminate, which laminating station is downstream of the marking station and the measuring station; and

d) at least one machining station, which is downstream of the laminating station, with a machining tool, it being possible for the machining tool and the laminate to be automatically positioned relative to one another as a function of the location marking and of the at least one distance and/or angle value.

The marking station and the measuring station can be integrated structurally in a single station (marking and measuring station), but it is also possible for two stations to be present that are arranged one behind another.

The location marking can be applied by various methods (known per se). Thus, it is known to produce inscriptions and markings in the interior of glass substrates by means of focused laser radiation (compare Lenk, A.; Morgenthal, L: Damage-free micromarking of glass. Glastechn. Ber. Glass Sci. Technol. 73 (2000) No. 9, 285-289). These methods offer the advantage that there is no need to use any additional materials, and so the markings produced thereby are, furthermore, extremely hard wearing.

A further possibility is offered by inkjet printing, an established technology for producing markings on glass and other solid surfaces. In the context of the inventive method, however, particular preference is given to the technologies offered by the company boraglas GmbH, Halle (Germany) under the trade names of MarcColor® and UniColor®, see also WO 07/031151 A1, WO 07/062860 A1 and EP 1 728 770 A2 (all boraglas GmbH). In the case of these, a dispenser medium is applied to the glass surface. In the case of the first-mentioned method, focused laser radiation is used to induce an ion exchange, silver ions diffuse into the glass and agglomerate as silver nanoparticles in the interior of the glass. In the case of the second method mentioned, a vitreous layer is formed with silver nanoparticles at the transition from the dispenser medium to the glass surface.

Further technologies for marking, such as, for example, an adhesive being applied at an exact location, can likewise be used within the context of the invention. Aside from optically readable markings that enable a particularly high positional accuracy, inductively or capacitively detectable markings, for example, are also conceivable.

It is preferred to apply two location markings at a distance from one another to the solid plate such that it is possible on the basis of said markings to always uniquely determine both the positioning and the orientation of the solid plate.

In order to apply the two (or more) location markings, the marking station can comprise a movably arranged marking head that can be moved to the corresponding positions.

Alternatively, the plate to be marked is moved in relation to a marking device.

The inventive method is suitable, in particular, for separating a projecting section of a layer of the laminate, in particular a back-side film, in which during the machining step the laminate and a separating tool for separating the projecting section are automatically positioned relative to one another as a function of the location marking and of the at least one distance and/or angle value.

Here, separating the back-side film (which is, for example, produced from polyester or polyvinylfluoride) poses requirements different from those for the separation of laminate intermediate layers enclosed between two glass plates (and, as the case may be, further layers).

To this end, the machining station is designed as a cutting station and comprises a separating tool for separating the projecting section. The laminate and the separating tool can be automatically positioned in relation to one another as a function of the location marking and of the at least one distance and/or angle value. In this case, the cutting tool can be of movable design, and/or the cutting station comprises a movable holding device for the laminate.

In a preferred embodiment of the cutting station, the separating tool comprises a rotating cutting blade. The latter is set in rotation for the cutting operation in such a way that its peripheral speed is greater than the relative speed between laminate and separating tool. The cutting blade can cooperate with a support roll that rests on the opposite side of the laminate. There is no need for the separating tool to be supported laterally on the irregular delimitation of the laminate or on the solid plate.

Other separating tools can be used as an alternative, for example cutting blades arranged in a stationary fashion on the separating tool, or separating tools that, when heated, act on the section to be separated, for example blades or laser cutters provided with heating devices.

Aside from the separation of the projecting section, the markings produced and the angle and/or distance values determined can also be used for further machining steps, for example in order to frame the laminate or to apply further elements to the laminate at accurate locations.

It is preferred within the context of the inventive method to apply a further marking for identifying the laminate to the solid plate. This can, in particular, be a data-encoding marking, for example a barcode or a two-dimensional data matrix, or a marking in plain text. This can assign the plate an identification code that is unique (at least for the working process), by means of which the plate (and later the laminate in which the plate is held) can always be identified without doubt in later steps. The further marking is advantageously applied in the same operation as the location markings. It is preferably optically readable, but it can also in this case be, for example, an RFID tag.

Alternatively, such a marking is dispensed with, and the system for machining the laminate comprises a system for tracking the workpieces such that it is possible to determine in the later machining operation which of the previously marked and measured workpiece is involved.

After having been determined, the at least one distance and/or angle value is advantageously acquired together with an identification of the laminate in a central database. It is then read out from this central database again in order to machine the laminate.

Alternatively, the determined measured values are stored directly on the laminate, for example, by producing a correspondingly encoded marking (for example, a two-dimensional data matrix), or by means of an RFID tag. The measured values can then be read out directly in a later machining station.

In a preferred exemplary embodiment, the laminate is substantially rectangular, and a camera that acquires a corner region of the solid plate is used to determine the at least one distance and/or angle value. The corners of a rectangular plate can easily be acquired, as a rule, and their position with reference to a marking can be determined uniquely by two numbers and, in addition, it is also possible to determine the effective angle. In the production of glass plates, the wave-like deviations of the outer edges are smaller by at least one order of magnitude by comparison with the further deviations from the exact rectangular shape. Consequently, the positions of all four corners uniquely determine the geometry of the contour of the substantially rectangular laminate except for the subordinate wave-like deviations. When use is made of a camera, it is advantageous when the location markings are arranged in the corner region of the plate such that both the corner of the solid plate and the respective location marking are simultaneously visible in the recording field of the camera such that the corresponding distance and/or angle value can be determined from a single recording.

A precise machining of the laminate can be achieved, in particular, in that when a two-dimensional laminate having a substantially polygonal shape is being machined, a number of distance and/or angle values is determined that suffices to uniquely define a polygonal contour of the laminate as well as a location reference and an orientation of this contour in relation to at least two location markings on the solid plate. By way of example, in the case of a quadrangular laminate, neglecting the waviness of the contours (see above) and deviations in the third dimension renders the two-dimensional coordinates of the four corner points with reference to the (two-dimensional) coordinate system defined by two location markings sufficient for a unique definition of the quadrangular shape.

The measuring station thus advantageously comprises four fixed cameras for simultaneously measuring four corner regions of a substantially rectangular solid plate. If such a number of cameras are available, relative movements between the plate and acquisition device are superfluous. The acquisition can therefore be performed precisely and quickly. Some or all of the cameras can, of course, be movably arranged in the measuring station such that laminates of different size can be processed one after another. However, no movements of the cameras or of the plate are required in order to use this embodiment for the complete measurement of a laminate in the context of the necessary information.

If necessary, after the lamination step, it is also still possible to undertake a determination of position of the laminate, in particular a determination in which the edge of the solid plate plays no role. The correspondingly determined position is acquired with reference to the location marking on the solid plate, and in a subsequent machining step the laminate and the machining tool are positioned relative to one another as a function of the location marking and of the position acquired with reference to the location marking. In the application, from the same applicant, filed as EP 08 405 123.4 on Apr. 30, 2008, the content of which is hereby incorporated into the present application, there is, for example, a description of a method for mounting a junction box on a solar panel. In the course of this method, the position of contact areas located inside the laminate is determined, for example by means of an inductive sensor. Subsequently, these contact areas are exposed, and a junction box is mounted on the back-side of the solar panel in such a way that terminal lugs of the junction box make contact with the exposed contact areas. In the context of the present invention, the positions of the contact areas can now be determined with reference to the location markings produced earlier. The exposure of the contact areas and/or the mounting of the junction box can be performed subsequently with reference to the location markings and in a fashion based on the correspondingly determined positions.

The machining station advantageously comprises a rotary table for holding the laminate and with the aid of which an angle correction of the laminate can be undertaken as a function of the location marking and the at least one distance and/or angle value. Such a rotary table enables an easy and quick angle correction. Said table can additionally be provided with devices for displacing the laminate in transverse and/or longitudinal fashion, and with a holding device for the laminate (for example a negative-pressure device or clamping devices).

The machining station advantageously comprises at least one camera for acquiring the location marking. Cameras are cost-effective and can be used flexibly. They enable a precise acquisition of optically readable location markings. If, for example, two location markings and one marking for identification are provided, a single camera capable of being moved in relation to the various markings can be present, or two cameras are present that are fixed during the acquisition process, and the marking for indication is arranged adjacent to a location marking (or serves at the same time as location marking) so that one of the two cameras can simultaneously acquire the location marking and the identification.

Further advantageous embodiments and combinations of features of the invention result from the following detailed description and the totality of the patent claims.

### BRIEF DESCRIPTION OF THE DRAWINGS

The drawings used to explain the exemplary embodiment show:

FIG. 1: A block schematic of an inventive system for producing solar panels;

FIG. 2: A schematic of the marking and measuring station of the system,

FIG. 3: A schematic of the markings produced;

FIG. 4: A schematic of the cutting station of the system,

FIG. 5: A schematic cross section through the cutting tool and the machined edge region of the laminate; and

FIGS. 6A-C: A schematic of the method for cutting off the projecting edge region of the back-side film.

Identical parts are provided with identical reference numerals in the figures as a matter of principle.

### DETAILED DESCRIPTION

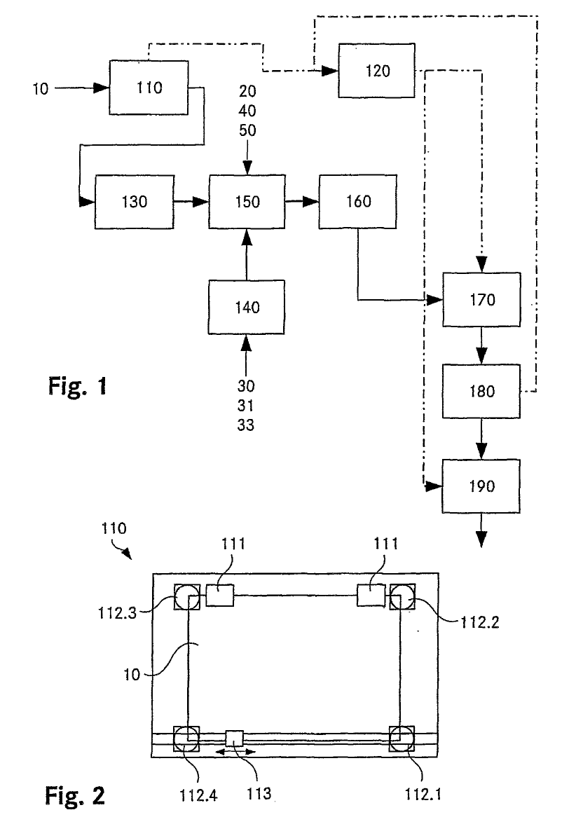

FIG. 1 is a block diagram schematic of an inventive system for producing solar panels. The solar panel 1 (compare FIG. 5) comprises a substantially rectangular glass plate 10 made from single pane safety glass as basic substrate. A layer system is constructed on said glass plate from a first transparent plastic layer 20 made from ethylene-vinyl acetate (EVA), a plurality of solar cells 30, known per se, a second plastic layer 40 made from ethylene-vinyl acetate (EVA), as well as a back-side film 50 made from polyester. The solar cells are electrically interconnected in a way known per se by longitudinal connectors 31 and transverse connectors 33.

The solar panel 1 is arranged (for example fastened on a building roof) in such a way that the glass plate 10 faces the sun. The insolation passes through the glass plate 10 and through the first transparent plastic layer 20 and strikes the solar cells 30, which are embedded between the plastic layers 20, 40, where an electrical voltage is generated.

For the purpose of fabricating the solar panel 1, the glass plate 10 is firstly provided in a marking and measuring stations 110 with two location markings, and measured. The measured data are transmitted to a central database 120, which is part of a system controller, and stored therein. In a further station 130, the glass plate 10 is cleaned and prepared for the further method steps. In a further station 140, the solar cells 30 are firstly connected to the longitudinal connectors 31 to form strings, and the strings are subsequently interconnected by means of the transverse connectors 33. Subsequently, in a further station 150, the layer system is mounted stepwise on the glass plate 10, that is to say there are laid on the glass plate 10 a first plastic film, made from EVA, for forming the first plastic layer 20, the interconnected solar cells 30 together with longitudinal and transverse connectors 31, 33, a second plastic film for forming the second plastic layer 40, and the back-side film 50. The next step is to laminate the module in a lamination device 160 at reduced pressure and approximately 150° C. Formed during the lamination from the up to then milky EVA plastic films are clear, three-dimensionally crosslinked plastic layers 20, 40 that can no longer be melted and in which the solar cells 30 and the connectors are now embedded, and which are firmly interconnected and also connected to the glass plate 10 and the back-side film 50. The EVA layers easily swell over the outer edge of the glass plate 10 to the outside.

Following the lamination, the edges are trimmed in a cutting station 170, the contact areas of the transverse connectors 33 are subsequently exposed in the next station 180, and finally a junction box is mounted in a further station 190. Following thereupon, the solar panel 1 can further be framed and measured and classified according to its electrical values, and packaged.

FIG. 2 is a schematic of the marking and measuring station 110. This comprises a support on which the glass plate 10 can be mounted, and holding devices 111 for securing the glass plate 110. Four cameras 112.1 . . . 112.4 are arranged at the marking and measuring station 110 in such a way that their recording fields can acquire the four corner regions of the glass plate 10. A marking head 113 is arranged such that it can be moved linearly along the long side of the mounted glass plate 10 on the long side of the support, which is situated opposite the holding devices 111.

The UniColor® method of boraglas GmbH (see above) is used to produce the desired markings. The first step for this purpose is for the dispenser medium to be applied to the glass surface, for example bonded on as a film, at the corresponding points, after which the points to be marked are locally heated by means of a laser accommodated in the marking head 113. A vitreous layer with silver nanoparticles is thereby produced on the glass surface under the influence of the laser radiation.

The glass plate 10 is cleaned in the following station 130, this removing even contaminants or smoke traces possibly produced during marking.

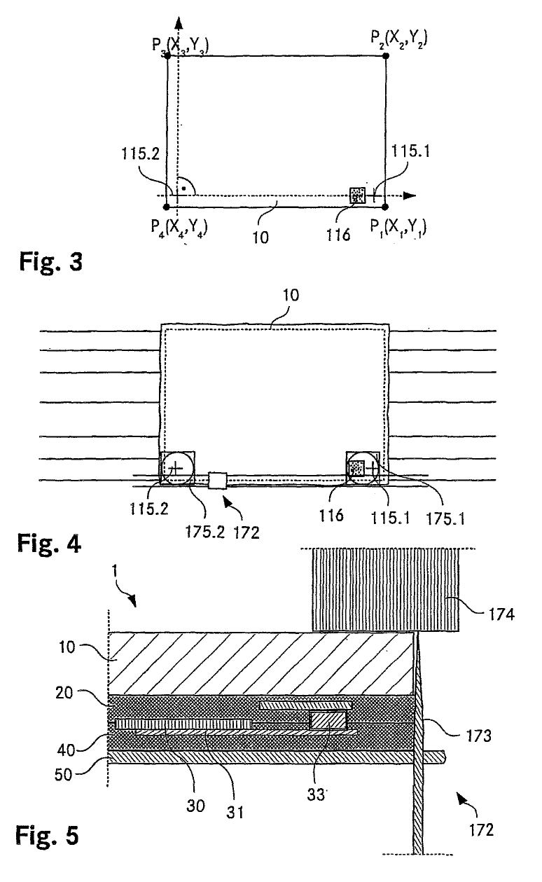

FIG. 3 is a schematic of the markings produced. These comprise two location markings 115.1, 115.2, respectively in the form of a cross produced in two corner regions of one of the long sides of the glass plate 10. A two-dimensional data matrix 116 has been applied in the same way to the glass surface in a fashion adjacent to the front location marking 115.1. Said data matrix codes a unique identification number for the glass plate 10. The two location markings 115.1, 115.2 define a two-dimensional Cartesian coordinate system whose origin is given by the rear location marking 115.2. The x-axis runs from the origin through the front location marking 115.1, while the y-axis is rotated in the clockwise direction by 90° in relation to the x-axis. Each of the four corner points P₁ . . . P₄ acquired by the cameras 112.1 . . . 112.4 can be represented by an XY-coordinate pair in this coordinate system. It should be noted that the x-axis need not necessarily run parallel to the long side of the glass plate 10, that is to say the location markings 115.1, 115.2 need not be at the same distance from the long side of the plate. Where the two location markings are applied is largely insignificant for the functioning of the invention. However, it is advantageous for the purpose of good precision when their spacing is sufficiently large.

FIG. 4 is a schematic of the cutting station 170. The latter comprises a rotary table 171 on which the solar panel 1 can be mounted. As may be seen from FIG. 4, sections of the back-side film (and, if appropriate, also of the laminating layers) project beyond the glass plate 10. Suction devices (not illustrated) hold the solar panel 1 securely against the bearing surface of the rotary table 171. Along with a transverse displacement of the solar panel 1, arbitrary rotary movements thereof are enabled by the rotary table 171 in a way known per se. A longitudinally displaceable cutting tool 172 is arranged at a long side of the rotary table 171. Furthermore, the cutting station has two cameras 175.1, 175.2 that are likewise arranged in the region of said long side and whose spacing is set in such a way that they can acquire the two location markings 115.1, 115.2 and also the data matrix 116. The front camera 175.1 in this case acquires simultaneously in its recording field the front location marking 115.1 and the data matrix 116, which is arranged alongside.

FIG. 5 shows a schematic cross section through the cutting tool 172 and the machined edge region of the laminate 1. The cutting tool comprises a circular rotating cutting blade 173, known per se, and a support roll 174 that is supported on the main side of the laminate 1, which is situated opposite the rotation axis of the cutting blade 173. The cutting blade 173 is designed in such a way that it is possible to separate sections of the back-side film 50 and of the laminating films 20, 40 projecting beyond the glass plate 10.

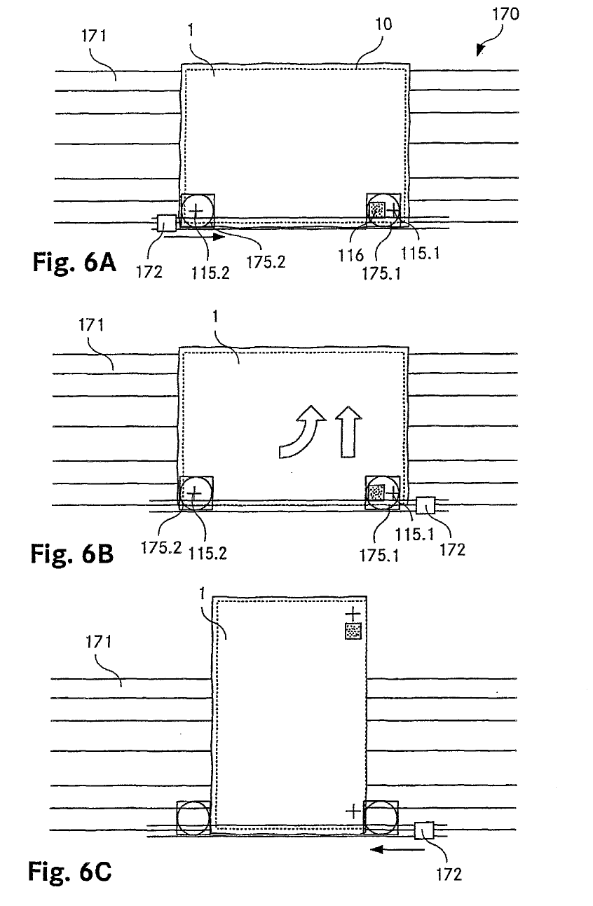

FIGS. 6A-C serve to illustrate the method for cutting off the protruding edge region of the back-side film.

The laminate 1 is firstly positioned on the rotary table 171 such that the two location markings 115.1, 115.2 and the data matrix 116 can be acquired by the two cameras 175.1, 175.2 arranged at the cutting station 170. Consequently, one long side of the laminate 1 is located approximately parallel to that edge of the support of the rotary table 171 which is provided with the two cameras 175.1, 175.2 (see FIG. 6A). The identification information read out from the data matrix 116 is sent to the database, whereupon the latter returns the measured data acquired in relation to the plate 10 of the laminate 1 to the cutting station 170. The measured data received and the location markings 115.1, 115.2 are then used with the aid of the rotary table 171 to position the laminate 1 in such a way that the desired cutting line coincides with the movement path of the cutting tool 172. In the exemplary embodiment illustrated, the cutting line is at a distance of 0.1-0.2 mm from the edge of the plate 10. The suction devices of the rotary table 171 are subsequently activated, resulting in the laminate 1 being secured on the support of the rotary table 171. The projecting section of the back-side film and, if appropriate, of the laminating films is/are then separated by a linear movement of the cutting tool 172; the result of this step is illustrated in FIG. 6B.

The next step is now, after the deactivation of the suction devices, to use the rotary table 171 to rotate the laminate 1 by 90° and displace it in a transverse direction such that a narrow side of the laminate 1 borders that edge of the support of the rotary table 171 which is provided with the cameras 175.1, 175.2. The positioning of the laminate 1 continues to be performed on the basis of the acquired measured data, whereas it is no longer necessary to acquire the location markings 115.1, 115.2 thereafter, since the further positioning steps are respectively performed relative to the previous position. After positioning has been performed, the laminate 1 is again located in a position such that the desired cutting line along the narrow side coincides with the movement path of the cutting tool 172. The projecting section of the back-side film and, if appropriate, of the laminating films can be separated, in turn, correspondingly by a linear movement of the cutting tool 172.

In the further course of the method (not illustrated), there are, again, two 90° rotations of the laminate 1, followed by corresponding corrections of the transverse position and by the operation of cutting off. Lastly, the laminate 1 is rotated, again, by 90° such that it again assumes its initial position on the rotary table 171 and can be conveyed further.

The invention is not restricted to the exemplary embodiment illustrated. Thus, an inventive system can comprise further stations, or individual stations can be omitted. The geometry of the holding devices and transport devices for the glass plate and/or for the laminate, and the number and arrangement of the cameras can be selected differently. Correspondingly, the position or the type for the markings can also differ; thus, location markings of different type are conceivable, or the marking for identification is a barcode instead of a data matrix. The distance and/or angle values used, and the corresponding coordinate system can likewise be selected otherwise. Thus, in one modification of the exemplary embodiment, it is possible by way of example to use combined distance and angle values, for example polar coordinates, instead of the four data pairs in the Cartesian coordinate system.

The glass plate or the machining device, respectively, can always be moved in the case of relative movements between the glass plate or the laminate, on the one hand, and a machining device (for example marking head, cutting device), on the other hand. The process of cutting off can be accelerated by providing two cutting devices situated opposite one another and which are able simultaneously to separate protruding sections on two opposite sides of the laminate. The cutting device can, moreover, be of different structural design.

It may be stated in summary that the invention provides a method and a system that enable a precise machining of laminates.

1. A method for machining a laminate that has at least one solid plate, in particular a glass plate, comprising the following steps:
a) applying at least one location marking to the solid plate prior to a lamination step and determining at least one distance and/or angle value of the solid plate with reference to the location marking; and
b) machining the laminate following the lamination step, the laminate and a machining tool being automatically positioned relative to one another as a function of the location marking and of the at least one distance and/or angle value.

2. The method as claimed in claim 1, for separating a projecting section of a layer of the laminate, in particular a back-side film, in which during the machining step the laminate and a separating tool for separating the projecting section are automatically positioned relative to one another as a function of the location marking and of the at least one distance and/or angle value.

3. The method as claimed in claim 1, whereas a further marking for identifying the laminate is applied to the solid plate.

4. The method as claimed in claim 1, whereas after being determined the at least one distance and/or angle value is acquired together with an identification of the laminate in a central database and is read out from this central database in order to machine the laminate.

5. The method as claimed claim 1, whereas the laminate is substantially rectangular, and in that a camera that acquires a corner region of the solid plate is used to determine the at least one distance and/or angle value.

6. The method as claimed in claim 1, whereas when a two-dimensional laminate having a substantially polygonal shape is being machined, a number of distance and/or angle values is determined that suffices to uniquely define a polygonal contour of the laminate as well as a location reference and an orientation of this contour in relation to at least two location markings on the solid plate.

7. The method as claimed in claim 1, whereas a determination of position on the laminate is undertaken after the lamination step, in that the determined position is acquired with reference to the location marking on the solid plate, and in that in a subsequent machining step the laminate and the machining tool are positioned relative to one another as a function of the location marking and of the position acquired with reference to the location marking.

8. A system for machining a laminate that has at least one solid plate, in particular a glass plate, comprising:
a) a marking station for applying a location marking to the solid plate;
b) a measuring station for determining at least one distance and/or angle value of the solid plate with reference to the location marking;
c) a laminating station for laminating the laminate, which laminating station is downstream of the marking station and the measuring station; and
d) at least one machining station, which is downstream of the laminating station, with a machining tool, it being possible for the machining tool and the laminate being automatically positioned relative to one another as a function of the location marking and of the at least one distance and/or angle value.

9. The system as claimed in claim 8, the marking station comprising a movably arranged marking head for applying at least two location markings to the solid plate.

10. The system as claimed in claim 8, the measuring station comprising four fixed cameras for simultaneously measuring four corner regions of a substantially rectangular solid plate.

11. The system as claimed in claim 8, the machining station comprising a rotary table for holding the laminate and with the aid of which an angle correction of the laminate can be undertaken as a function of the location marking and the at least one distance and/or angle value.

12. The system as claimed in claim 8, the machining station comprising at least one camera for acquiring the location marking.

13. The system as claimed in claim 8, whereas the machining station is a cutting station for separating a projecting section of a layer of the laminate, in particular a back-side film, the cutting station comprising a separating tool for separating the projecting section, the laminate and the separating tool to be automatically positioned relative to one another as a function of the location marking and of the at least one distance and/or angle value.

14. The system as claimed in claim 13, the separating tool comprising a rotating cutting blade.
